(19) United States
(12) Patent Application Publication
(10) Pub. No.: US 2024/0380904 A1
(43) Pub. Date: Nov. 14, 2024

(54) METHOD, APPARATUS, AND MEDIUM FOR DATA PROCESSING

(71) Applicants: Beijing Bytedance Network Technology Co., Ltd., Beijing (CN); Bytedance Inc., Los Angeles, CA (US)

(72) Inventors: Semih ESENLIK, Los Angeles, CA (US); Yaojun WU, Beijing (CN); Zhaobin ZHANG, Los Angeles, CA (US); Yue LI, Los Angeles, CA (US); Kai ZHANG, Los Angeles, CA (US); Li ZHANG, Los Angeles, CA (US)

(21) Appl. No.: 18/778,813

(22) Filed: Jul. 19, 2024

Related U.S. Application Data
(63) Continuation of application No. PCT/CN2023/073425, filed on Jan. 20, 2023.

(30) Foreign Application Priority Data
Jan. 21, 2022 (WO) PCT/CN2022/073105

(51) Int. Cl. H04N 19/189; H04N 19/119; H04N 19/124; H04N 19/132; H04N 19/436

(52) U.S. Cl. CPC H04N 19/189; H04N 19/119; H04N 19/124; H04N 19/132; H04N 19/436

(57) ABSTRACT

Embodiments of the present disclosure provide a solution for data processing. A method for data processing is proposed. The method comprises: processing, during a conversion between data and a bitstream of the data, a first set of samples of a reconstructed latent representation of the data and a second set of samples of the reconstructed latent representation by using a model, the first set of samples being associated with a first sample of the reconstructed latent representation and the second set of samples being associated with a second sample of the reconstructed latent representation; and performing the conversion based on a result of the processing.

### CROSS REFERENCE

This application is a continuation of International Application No. PCT/CN2023/073425, filed on Jan. 20, 2023, which claims the benefit of International Application No. PCT/CN2022/073105 filed on Jan. 21, 2023. The entire contents of these applications are hereby incorporated by reference in their entireties.

### FIELD

Embodiments of the present disclosure relates generally to data processing techniques, and more particularly, to neural network-based data coding.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding efficiency of neural network-based image/video coding is generally expected to be further improved.

### SUMMARY

Embodiments of the present disclosure provide a solution for data processing.

In a first aspect, a method for data processing is proposed. The method comprises: processing, during a conversion between data and a bitstream of the data, a first set of samples of a reconstructed latent representation of the data and a second set of samples of the reconstructed latent representation by using a model, the first set of samples being associated with a first sample of the reconstructed latent representation and the second set of samples being associated with a second sample of the reconstructed latent representation; and performing the conversion based on a result of the processing.

According to the method in accordance with the first aspect of the present disclosure, the first set of samples and the second set of samples are processed in parallel by the model. Compared with the conventional solution where the first set of samples and the second set of samples are processed in serial, the proposed method can advantageously speed up the processing, and thus the coding efficiency can be improved.

In a second aspect, an apparatus for processing data is proposed. The apparatus for processing data comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of data which is generated by a method performed by a data processing apparatus. The method comprises: processing a first set of samples of a reconstructed latent representation of the data and a second set of samples of the reconstructed latent representation by using a model, the first set of samples being associated with a first sample of the reconstructed latent representation and the second set of samples being associated with a second sample of the reconstructed latent representation; and generating the bitstream based on a result of the processing.

In a fifth aspect, a method for storing a bitstream of data is proposed. The method comprises: processing a first set of samples of a reconstructed latent representation of the data and a second set of samples of the reconstructed latent representation by using a model, the first set of samples being associated with a first sample of the reconstructed latent representation and the second set of samples being associated with a second sample of the reconstructed latent representation; generating the bitstream based on a result of the processing; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example data coding system, in accordance with some embodiments of the present disclosure;

FIG. 2 illustrates a typical transform coding scheme;

FIG. 3 illustrates an image from the Kodak dataset and different representations of the image;

FIG. 4 illustrates a network architecture of an autoencoder implementing the hyperprior model;

FIG. 5 illustrates a block diagram of a combined model;

FIG. 6 illustrates an encoding process of the combined model;

FIG. 7 illustrates a decoding process of the combined model;

FIG. 8A illustrates the state-of-the-art decoder design;

FIG. 8B illustrates a raster scan processing order;

FIG. 9 illustrates an entropy coding part of the state-of-the-art decoding architecture;

FIG. 10 illustrates a kernel of context model in state of the art;

FIG. 11 illustrates the processing of the samples of the quantized latent;

FIG. 12 illustrates a processing kernel of the autoregressive network according to some embodiments of the present disclosure;

FIG. 13 illustrates the processing kernel shown in FIG. 12 in the context of processing of the samples of the quantized latent;

FIG. 14 illustrates a filter kernel that is used to process a current sample according to some embodiments of the present disclosure;

FIG. 15A illustrates a processing pattern of the quantized latent according to some embodiments of the present disclosure;

FIG. 15B illustrates a kernel shape where T=0 according to some embodiments of the present disclosure;

FIG. 15C illustrates a processing pattern where T=0 according to some embodiments of the present disclosure;

FIG. 16 illustrates an example processing kernel according to some embodiments of the present disclosure;

FIG. 17 illustrates exemplary symmetric filter kernels according to some embodiments of the present disclosure;

FIG. 18 illustrates further exemplary symmetric filter kernels according to some embodiments of the present disclosure;

FIG. 19A illustrates another example processing kernel according to some embodiments of the present disclosure;

FIG. 19B illustrates a further example processing kernel according to some embodiments of the present disclosure;

FIG. 20 illustrates a flowchart of a method for data processing in accordance with some embodiments of the present disclosure;

FIG. 21 illustrates an example processing pattern according to some embodiments of the present disclosure; and

FIG. 22 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

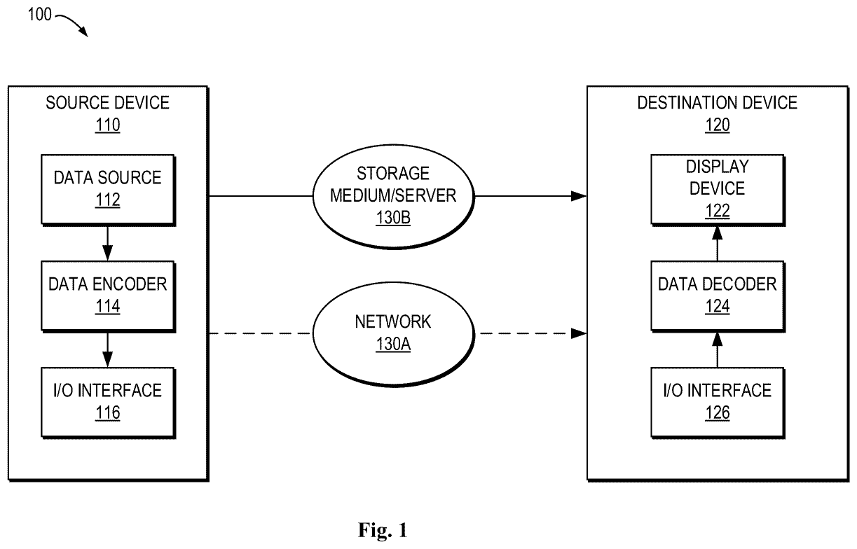

FIG. 1 is a block diagram that illustrates an example data coding system 100 that may utilize the techniques of this disclosure. As shown, the data coding system 100 may include a source device 110 and a destination device 120. The source device 110 can be also referred to as a data encoding device, and the destination device 120 can be also referred to as a data decoding device. In operation, the source device 110 can be configured to generate encoded data and the destination device 120 can be configured to decode the encoded data generated by the source device 110. The source device 110 may include a data source 112, a data encoder 114, and an input/output (I/O) interface 116.

The data source 112 may include a source such as a data capture device. Examples of the data capture device include, but are not limited to, an interface to receive data from a data provider, a computer graphics system for generating data, and/or a combination thereof.

The data may comprise one or more pictures of a video or one or more images. The data encoder 114 encodes the data from the data source 112 to generate a bitstream. The bitstream may include a sequence of bits that form a coded representation of the data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded data may be transmitted directly to destination device 120 via the I/O interface 116 through the network 130A. The encoded data may also be stored onto a storage medium/server 130B for access by destination device 120.

The destination device 120 may include an I/O interface 126, a data decoder 124, and a display device 122. The I/O interface 126 may include a receiver and/or a modem. The I/O interface 126 may acquire encoded data from the source device 110 or the storage medium/server 130B. The data decoder 124 may decode the encoded data. The display device 122 may display the decoded data to a user. The display device 122 may be integrated with the destination device 120, or may be external to the destination device 120 which is configured to interface with an external display device.

The data encoder 114 and the data decoder 124 may operate according to a data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific data codecs, the disclosed techniques are applicable to other coding technologies also. Furthermore, while some embodiments describe coding steps in detail, it will be understood that corresponding steps decoding that undo the coding will be implemented by a decoder. Furthermore, the term data processing encompasses data coding or compression, data decoding or decompression and data transcoding in which data are represented from one compressed format into another compressed format or at a different compressed bitrate.

### 1. Summary

A neural network-based image and video compression method is proposed, wherein an autoregressive subnetwork is utilized. The disclosure targets the problem of slow processing with autoregressive subnetwork by enabling concurrent processing of multiple samples.

### 2. Background

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable R-D performance with Versatile Video Coding (VVC), the latest video coding standard developed by Joint Video Experts Team (JVET) with experts from MPEG and VCEG. With the performance of neural image compression continually being improved, neural network-based video compression has become an actively developing research area. However, neural network-based video coding still remains in its infancy due to the inherent difficulty of the problem.

### 2.1. Image/Video Compression

Image/video compression usually refers to the computing technology that compresses image/video into binary code to facilitate storage and transmission. The binary codes may or may not support losslessly reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e. compression ratio and reconstruction quality. Compression ratio is directly related to the number of binary codes, the less the better; Reconstruction quality is measured by comparing the reconstructed image/video with the original image/video, the higher the better. Image/video compression techniques can be divided into two branches, the classical video coding methods and the neural-network-based video compression methods. Classical video coding schemes adopt transform-based solutions, in which researchers have exploited statistical dependency in the latent variables (e.g., DCT or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

In the last three decades, a series of classical video coding standards have been developed to accommodate the increasing visual content. The international standardization organizations ISO/IEC has two expert groups namely Joint Photographic Experts Group (JPEG) and Moving Picture Experts Group (MPEG), and ITU-T also has its own Video Coding Experts Group (VCEG) which is for standardization of image/video coding technology. The influential video coding standards published by these organizations include JPEG, JPEG 2000, H.262, H.264/AVC and H.265/HEVC. After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

Neural network-based image/video compression is not a new invention since there were a number of researchers working on neural network-based image coding. But the network architectures were relatively shallow, and the performance was not satisfactory. Benefit from the abundance of data and the support of powerful computing resources, neural network-based methods are better exploited in a variety of applications. At present, neural network-based image/video compression has shown promising improvements, confirmed its feasibility. Nevertheless, this technology is still far from mature and a lot of challenges need to be addressed.

2.2. Neural Networks Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.
2.3. Neural Networks for Image Compression Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.
2.3.1 Pixel Probability Modeling According to Shannon's information theory, the optimal method for lossless coding can reach the minimal coding rate—log₂ p(x) where p(x) is the probability of symbol x. A number of lossless coding methods were developed in literature and among them arithmetic coding is believed to be among the optimal ones. Given a probability distribution p(x), arithmetic coding ensures that the coding rate to be as close as possible to its theoretical limit—log₂ p(x) without considering the rounding error. Therefore, the remaining problem is to how to determine the probability, which is however very challenging for natural image/video due to the curse of dimensionality. Following the predictive coding strategy, one way to model p(x) is to predict pixel probabilities one by one in a raster scan order based on previous observations, where x is an image.

$$p ( x ) = p ( {x}_{1} ) p ( {x}_{2} \vert {x}_{1} ) … p ( {x}_{i} \vert {x}_{1 ,} {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, it can be difficult to estimate the conditional probability, thereby a simplified method is to limit the range of its context.

$$p ( x ) = p ( {x}_{1} ) p ( {x}_{2} \vert {x}_{1} ) … p ( {x}_{i} \vert {x}_{i - k ,} {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the RGB color component, R sample is dependent on previously coded pixels (including R/G/B samples), the current G sample may be coded according to previously coded pixels and the current R sample, while for coding the current B sample, the previously coded pixels and the current R and G samples may also be taken into consideration. Neural networks were originally introduced for computer vision tasks and have been proven to be effective in regression and classification problems. Therefore, it has been proposed using neural networks to estimate the probability of p(xᵢ) given its context x₁, x₂, . . . , xᵢ₋₁. In an existing design, the pixel probability is proposed for binary images, i.e., xᵢ∈{−1, +1}. The neural autoregressive distribution estimator (NADE) is designed for pixel probability modeling, where is a feed-forward network with a single hidden layer. A similar work is presented in an existing design, where the feed-forward network also has connections skipping the hidden layer, and the parameters are also shared. Experiments are performed on the binarized MNIST dataset. In an existing design, NADE is extended to a real-valued model RNADE, where the probability p(x₁|x₁, . . . , xᵢ₋₁) is derived with a mixture of Gaussians. Their feed-forward network also has a single hidden layer, but the hidden layer is with rescaling to avoid saturation and uses rectified linear unit (ReLU) instead of sigmoid. In an existing design, NADE and RNADE are improved by using reorganizing the order of the pixels and with deeper neural networks. Designing advanced neural networks plays an important role in improving pixel probability modeling. In an existing design, multi-dimensional long short-term memory (LSTM) is proposed, which is working together with mixtures of conditional Gaussian scale mixtures for probability modeling. LSTM is a special kind of recurrent neural networks (RNNs) and is proven to be good at modeling sequential data. The spatial variant of LSTM is used for images later in an existing design. Several different neural networks are studied, including RNNs and CNNs namely PixelRNN and PixelCNN, respectively. In PixelRNN, two variants of LSTM, called row LSTM and diagonal BiLSTM are proposed, where the latter is specifically designed for images. PixelRNN incorporates residual connections to help train deep neural networks with up to 12 layers. In PixelCNN, masked convolutions are used to suit for the shape of the context. Comparing with previous works, PixelRNN and PixelCNN are more dedicated to natural images: they consider pixels as discrete values (e.g., 0, 1, . . . , 255) and predict a multinomial distribution over the discrete values; they deal with color images in RGB color space; they work well on large-scale image dataset ImageNet. In an existing design, Gated PixelCNN is proposed to improve the PixelCNN, and achieves comparable performance with PixelRNN but with much less complexity. In an existing design, PixelCNN++ is proposed with the following improvements upon PixelCNN: a discretized logistic mixture likelihood is used rather than a 256-way multinomial distribution; down-sampling is used to capture structures at multiple resolutions; additional short-cut connections are introduced to speed up training; dropout is adopted for regularization; RGB is combined for one pixel. In an existing design, PixelSNAIL is proposed, in which casual convolutions are combined with self-attention.

Most of the above methods directly model the probability distribution in the pixel domain. Some researchers also attempt to model the probability distribution as a conditional one upon explicit or latent representations. That being said, the following may be estimated:

$$p ( x \vert h ) = {\prod }_{i = I}^{m \times n} p ( {x}_{i} \vert {x}_{1 ,} {x}_{i - 1} , h ) \qquad ( 3 )$$

where h is the additional condition and p(x)=p(h)p(x|h), meaning the modeling is split into an unconditional one and a conditional one. The additional condition can be image label information or high-level representations.

### 2.3.2 Auto-Encoder

Auto-encoder originates from the well-known work proposed in an existing design. The method is trained for dimensionality reduction and consists of two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks.

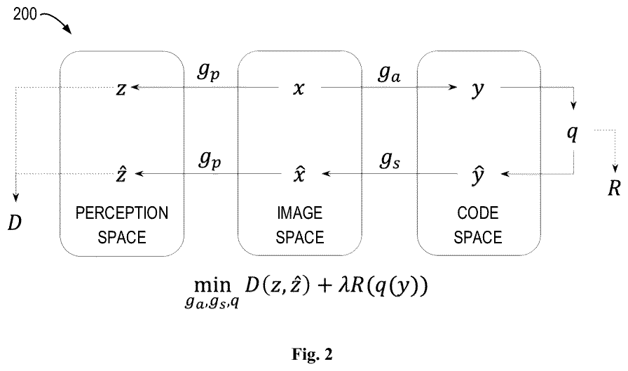

FIG. 2 illustrates a typical transform coding scheme. The original image x is transformed by the analysis network gₐ to achieve the latent representation y. The latent representation y is quantized and compressed into bits. The number of bits R is used to measure the coding rate. The quantized latent representation ŷ is then inversely transformed by a synthesis network gₛ to obtain the reconstructed image \hat{x}. The distortion is calculated in a perceptual space by transforming x and \hat{x} with the function gₚ.

It is intuitive to apply auto-encoder network to lossy image compression. We only need to encode the learned latent representation from the well-trained neural networks. However, it is not trivial to adapt auto-encoder to image compression since the original auto-encoder is not optimized for compression thereby not efficient by directly using a trained auto-encoder. In addition, there exist other major challenges: First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area. The prototype auto-encoder for image compression is in FIG. 2, which can be regarded as a transform coding strategy. The original image x is transformed with the analysis network y=gₐ(x), where y is the latent representation which will be quantized and coded. The synthesis network will inversely transform the quantized latent representation ŷ back to obtain the reconstructed image \hat{x}=gₛ (ŷ). The framework is trained with the rate-distortion loss function, i.e., [symbol] =D+λR, where D is the distortion between x and \hat{x}, R is the rate calculated or estimated from the quantized representation ŷ, and λ is the Lagrange multiplier. It should be noted that D can be calculated in either pixel domain or perceptual domain. All existing research works follow this prototype and the difference might only be the network structure or loss function.

In terms of network structure, RNNs and CNNs are the most widely used architectures. In the RNNs relevant category, Toderici et al. propose a general framework for variable rate image compression using RNN. They use binary quantization to generate codes and do not consider rate during training. The framework indeed provides a scalable coding functionality, where RNN with convolutional and deconvolution layers is reported to perform decently. Toderici et al. then proposed an improved version by upgrading the encoder with a neural network similar to PixelRNN to compress the binary codes. The performance is reportedly better than JPEG on Kodak image dataset using MS-SSIM evaluation metric. Johnston et al. further improve the RNN-based solution by introducing hidden-state priming. In addition, an SSIM-weighted loss function is also designed, and spatially adaptive bitrates mechanism is enabled. They achieve better results than BPG on Kodak image dataset using MS-SSIM as evaluation metric. Covell et al. support spatially adaptive bitrates by training stop-code tolerant RNNs.

Ballé et al. proposes a general framework for rate-distortion optimized image compression. The use multiary quantization to generate integer codes and consider the rate during training, i.e. the loss is the joint rate-distortion cost, which can be MSE or others. They add random uniform noise to stimulate the quantization during training and use the differential entropy of the noisy codes as a proxy for the rate. They use generalized divisive normalization (GDN) as the network structure, which consists of a linear mapping followed by a nonlinear parametric normalization. The effectiveness of GDN on image coding is verified in an existing design. Ballé et al. then propose an improved version, where they use 3 convolutional layers each followed by a down-sampling layer and a GDN layer as the forward transform. Accordingly, they use 3 layers of inverse GDN each followed by an up-sampling layer and convolution layer to stimulate the inverse transform. In addition, an arithmetic coding method is devised to compress the integer codes. The performance is reportedly better than JPEG and JPEG 2000 on Kodak dataset in terms of MSE. Furthermore, Ballé et al. improve the method by devising a scale hyper-prior into the auto-encoder. They transform the latent representation y with a subnet hₐ to z=hₐ(y) and z will be quantized and transmitted as side information. Accordingly, the inverse transform is implemented with a subnet hₛ attempting to decode from the quantized side information \hat{z} to the standard deviation of the quantized ŷ, which will be further used during the arithmetic coding of ŷ. On the Kodak image set, their method is slightly worse than BPG in terms of PSNR. D. Minnen et al. further exploit the structures in the residue space by introducing an autoregressive model to estimate both the standard deviation and the mean. In an existing design, Z. Cheng et al. use Gaussian mixture model to further remove redundancy in the residue. The reported performance is on par with VVC on the Kodak image set using PSNR as evaluation metric.

### 2.3.3 Hyper Prior Model

In the transform coding approach to image compression, the encoder subnetwork (section 2.3.2) transforms the image vector x using a parametric analysis transform gₐ(x, ø_{g}) into a latent representation y, which is then quantized to form ŷ. Because ŷ is discrete-valued, it can be losslessly compressed using entropy coding techniques such as arithmetic coding and transmitted as a sequence of bits.

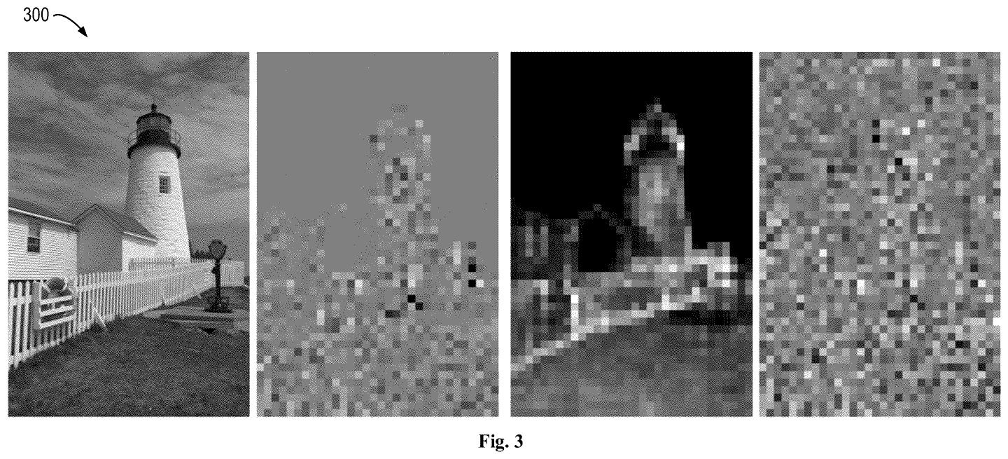

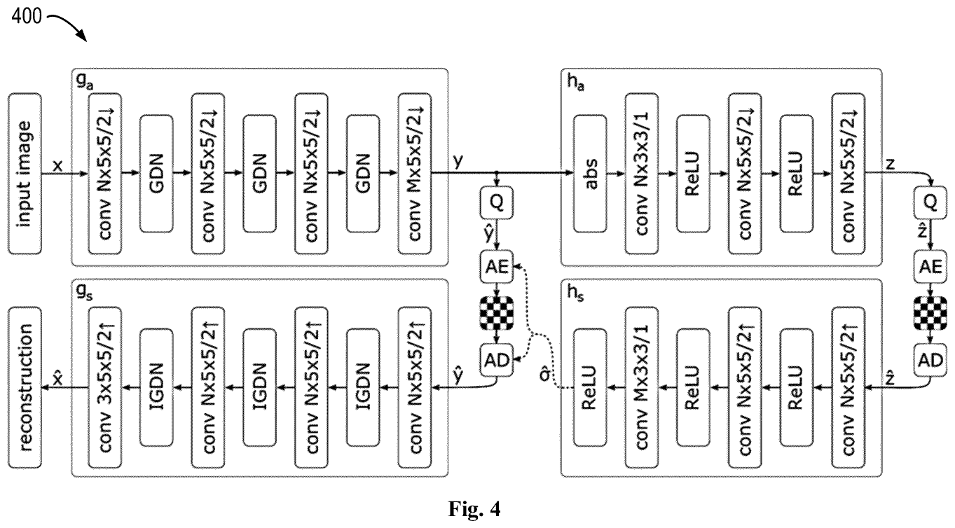

As evident from the middle left and middle right image of FIG. 3, there are significant spatial dependencies among the elements of ŷ. Notably, their scales (middle right image) appear to be coupled spatially. In an existing design, an additional set of random variables \hat{z} are introduced to capture the spatial dependencies and to further reduce the redundancies. In this case the image compression network is depicted in FIG. 4.

In FIG. 4, the left hand of the models is the encoder gₐ and decoder gₛ(explained in section 2.3.2). The right-hand side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ. the spatial distribution of standard deviations, and uses it to compress and transmit the quantized image representation ŷ. The decoder first recovers \hat{z} from the compressed signal. It then uses hₛ to obtain σ, which provides it with the correct probability estimates to successfully recover ŷ as well. It then feeds ŷ into gₛ to obtain the reconstructed image.

When the hyper encoder and hyper decoder are added to the image compression network, the spatial redundancies of the quantized latent ŷ are reduced. The rightmost image in FIG. 3 correspond to the quantized latent when hyper encoder/decoder are used. Compared to middle right image, the spatial redundancies are significantly reduced, as the samples of the quantized latent are less correlated.

FIG. 3 illustrates an image from the Kodak dataset and different representations of the image. The leftmost image in FIG. 3 shows an image from the Kodak dataset. The middle left image in FIG. 3 shows visualization of a latent representation y of that image. The middle right image in FIG. 3 shows standard deviations σ of the latent. The rightmost image in FIG. 3 shows latents y after the hyper prior (hyper encoder and decoder) network is introduced.

FIG. 4 illustrates a network architecture of an autoencoder implementing the hyperprior model. The left side shows an image autoencoder network, the right side corresponds to the hyperprior subnetwork. The analysis and synthesis transforms are denoted as gₐ and gₛ, respectively. Q represents quantization, and AE, AD represent arithmetic encoder and arithmetic decoder, respectively. The hyperprior model consists of two subnetworks, hyper encoder (denoted with hₐ) and hyper decoder (denoted with hₛ). The hyper prior model generates a quantized hyper latent (\hat{z}) which comprises information about the probability distribution of the samples of the quantized latent ŷ. \hat{z} is included in the bitsteam and transmitted to the receiver (decoder) along with ŷ.

### 2.3.4 Context Model

Although the hyperprior model improves the modelling of the probability distribution of the quantized latent ŷ, additional improvement can be obtained by utilizing an autoregressive model that predicts quantized latents from their causal context (Context Model).

The term auto-regressive means that the output of a process is later used as input to it. For example the context model subnetwork generates one sample of a latent, which is later used as input to obtain the next sample.

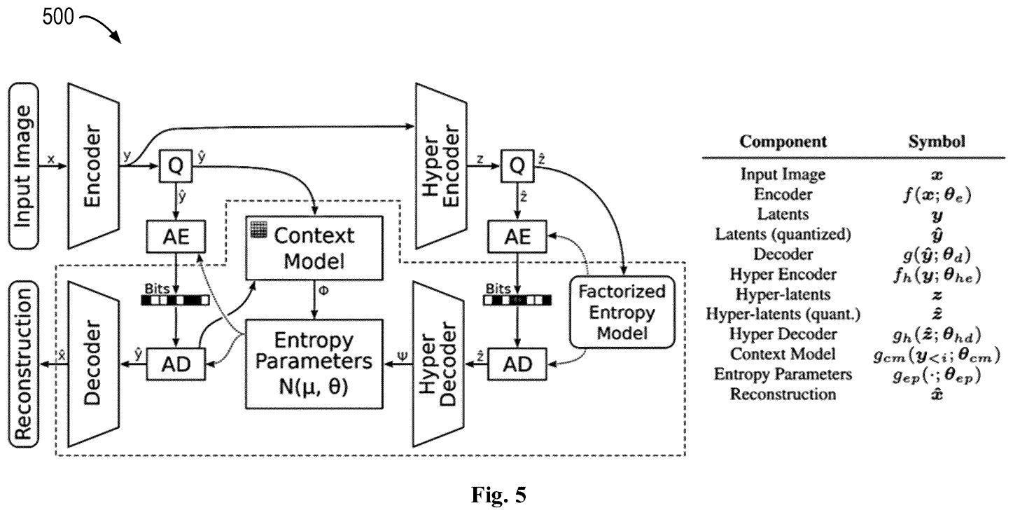

An existing design utilizes a joint architecture where both hyperprior model subnetwork (hyper encoder and hyper decoder) and a context model subnetwork are utilized. The hyperprior and the context model are combined to learn a probabilistic model over quantized latents ŷ, which is then used for entropy coding. As depicted in FIG. 5, the outputs of context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

FIG. 5 illustrates a block diagram of a combined model. The combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The highlighted region corresponds to the components that are executed by the receiver (i.e. a decoder) to recover an image from a compressed bitstream.

Typically, the latent samples are modeled as gaussian distribution or gaussian mixture models (not limited to). In an existing design and according to the FIG. 5, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5 the Encoding Process Using Joint Auto-Regressive Hyper Prior Model

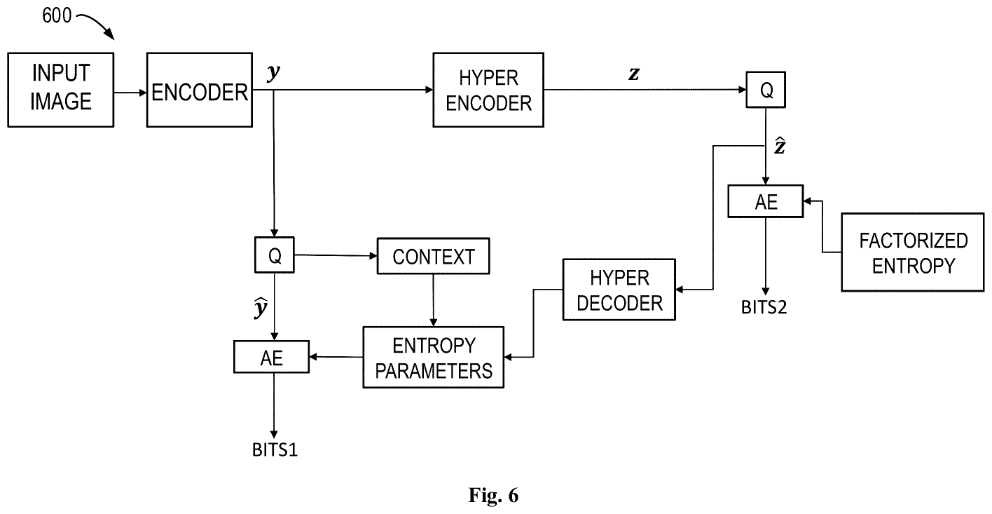

The FIG. 5 corresponds to the state of the art compression method that is proposed in an existing design. In this section and the next, the encoding and decoding processes will be described separately. The FIG. 6 depicts the encoding process. The input image is first processed with an encoder subnetwork. The encoder transforms the input image into a transformed representation called latent, denoted by y. y is then input to a quantizer block, denoted by Q, to obtained the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order. The modules hyper encoder, context, hyper decoder, and entropy parameters subnetworks are used to estimate the probability distributions of the samples of the quantized latent ŷ. The latent ŷ is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} ( \frac{x - μ}{σ} )}$$

wherein the parameter μ is the mean or expectation of the distribution (and also its median and mode), while the parameter σ is its standard deviation (or variance, or scale). In order to define a gaussian distribution, the mean and the variance need to be determined. In an existing design, the entropy parameters module are used to estimate the mean and the variance values. The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally the first and the second bitstream are transmitted to the decoder as result of the encoding process.

It is noted that the other names can be used for the modules described above.

In the above description, the all of the elements in FIG. 6 are collectively called encoder. The analysis transform that converts the input image into latent representation is also called an encoder (or auto-encoder).

### 2.3.6 the Decoding Process Using Joint Auto-Regressive Hyper Prior Model

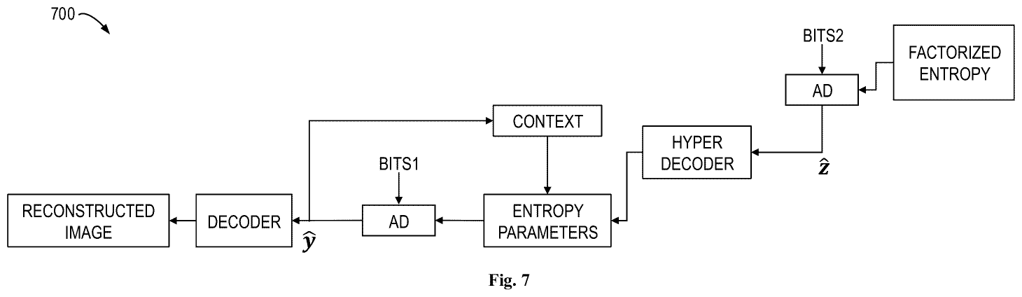

The FIG. 7 depicts the decoding process separately. In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore the exact same probability distributions can be obtained in the decoder (as in encoder), which is essential for reconstructing the quantized latent ŷ without any loss. As a result the identical version of the quantized latent ŷ that was obtained in the encoder can be obtained in the decoder.

After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore can not be sped up using techniques such as parallelization. Finally the fully reconstructed quantized latent ŷ is input to the synthesis transform (denoted as decoder in FIG. 7) module to obtain the reconstructed image.

In the above description, the all of the elements in FIG. 7 are collectively called decoder. The synthesis transform that converts the quantized latent into reconstructed image is also called a decoder (or auto-decoder).

### 2.4. Neural Networks for Video Compression

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently.

Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 2.4.1 Low-Latency

Chen et al. are the first to propose a video compression scheme with trained neural networks. They first split the video sequence frames into blocks and each block will choose one from two available modes, either intra coding or inter coding. If intra coding is selected, there is an associated auto-encoder to compress the block. If inter coding is selected, motion estimation and compensation are performed with tradition methods and a trained neural network will be used for residue compression. The outputs of auto-encoders are directly quantized and coded by the Huffman method.

Chen et al. propose another neural network-based video coding scheme with PixelMotionCNN. The frames are compressed in the temporal order, and each frame is split into blocks which are compressed in the raster scan order. Each frame will firstly be extrapolated with the preceding two reconstructed frames. When a block is to be compressed, the extrapolated frame along with the context of the current block are fed into the PixelMotionCNN to derive a latent representation. Then the residues are compressed by the variable rate image scheme. This scheme performs on par with H.264.

Lu et al. propose the real-sense end-to-end neural network-based video compression framework, in which all the modules are implemented with neural networks. The scheme accepts current frame and the prior reconstructed frame as inputs and optical flow will be derived with a pre-trained neural network as the motion information. The motion information will be warped with the reference frame followed by a neural network generating the motion compensated frame. The residues and the motion information are compressed with two separate neural auto-encoders. The whole framework is trained with a single rate-distortion loss function. It achieves better performance than H.264.

Rippel et al. propose an advanced neural network-based video compression scheme. It inherits and extends traditional video coding schemes with neural networks with the following major features: 1) using only one auto-encoder to compress motion information and residues; 2) motion compensation with multiple frames and multiple optical flows; 3) an on-line state is learned and propagated through the following frames over time. This scheme achieves better performance in MS-SSIM than HEVC reference software.

J. Lin et al. propose an extended end-to-end neural network-based video compression framework. In this solution, multiple frames are used as references. It is thereby able to provide more accurate prediction of current frame by using multiple reference frames and associated motion information. In addition, motion field prediction is deployed to remove motion redundancy along temporal channel. Postprocessing networks are also introduced in this work to remove reconstruction artifacts from previous processes. The performance is better than H.265 by a noticeable margin in terms of both PSNR and MS-SSIM.

Eirikur et al. propose scale-space flow to replace commonly used optical flow by adding a scale parameter. It is reportedly achieving better performance than H.264.

Z. Hu et al. propose a multi-resolution representation for optical flows. Concretely, the motion estimation network produces multiple optical flows with different resolutions and let the network to learn which one to choose under the loss function. The performance is slightly improved and better than H.265.

### 2.4.2 Random Access

Wu et al. propose a neural network-based video compression scheme with frame interpolation. The key frames are first compressed with a neural image compressor and the remaining frames are compressed in a hierarchical order. They perform motion compensation in the perceptual domain, i.e. deriving the feature maps at multiple spatial scales of the original frame and using motion to warp the feature maps, which will be used for the image compressor. The method is reportedly on par with H.264.

Djelouah et al. propose a method for interpolation-based video compression, wherein the interpolation model combines motion information compression and image synthesis, and the same auto-encoder is used for image and residual.

Amirhossein et al. propose a neural network-based video compression method based on variational auto-encoders with a deterministic encoder. Concretely, the model consists of an auto-encoder and an auto-regressive prior. Different from previous methods, this method accepts a group of pictures (GOP) as inputs and incorporates a 3D autoregressive prior by taking into account of the temporal correlation while coding the laten representations. It provides comparative performance as H.265.

### 2.5. Preliminaries

Almost all the natural image/video is in digital format. A grayscale digital image can be represented by x∈ [symbol] ^{m×n}, where [symbol] is the set of values of a pixel, m is the image height and n is the image width. For example, [symbol] ={0, 1, 2, . . . , 255} is a common setting and in this case | [symbol] |=256=2⁸, thus the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] ^{m×n×3} with three separate channels storing Red, Green and Blue information. Similar to the 8-bit grayscale image, an uncompressed 8-bit RGB image has 24 bpp. Digital images/videos can be represented in different color spaces. The neural network-based video compression schemes are mostly developed in RGB color space while the traditional codecs typically use YUV color space to represent the video sequences. In YUV color space, an image is decomposed into three channels, namely Y, Cb and Cr, where Y is the luminance component and Cb/Cr are the chroma components. The benefits come from that Cb and Cr are typically down sampled to achieve pre-compression since human vision system is less sensitive to chroma components.

A color video sequence is composed of multiple color images, called frames, to record scenes at different timestamps. For example, in the RGB color space, a color video can be denoted by X={x₀, x₁, . . . , xₜ, . . . , x_{T-1}} where T is the number of frames in this video sequence, x∈ [symbol] ^{m×n}. If m=1080, n=1920, | [symbol] |=28, and the video has 50 frames-per-second (fps), then the data rate of this uncompressed video is 1920×1080×8×3×50=2,488,320,000 bits-per-second (bps), about 2.32 Gbps, which needs a lot storage thereby definitely needs to be compressed before transmission over the internet.

Usually the lossless methods can achieve compression ratio of about 1.5 to 3 for natural images, which is clearly below requirement. Therefore, lossy compression is developed to achieve further compression ratio, but at the cost of incurred distortion. The distortion can be measured by calculating the average squared difference between the original image and the reconstructed image, i.e., mean-squared-error (MSE). For a grayscale image, MSE can be calculated with the following equation.

$$MSE = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{MSE} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).

To compare different lossless compression schemes, it is sufficient to compare either the compression ratio given the resulting rate or vice versa. However, to compare different lossy compression methods, it has to take into account both the rate and reconstructed quality. For example, to calculate the relative rates at several different quality levels, and then to average the rates, is a commonly adopted method; the average relative rate is known as Bjontegaard's delta-rate (BD-rate). There are other important aspects to evaluate image/video coding schemes, including encoding/decoding complexity, scalability, robustness, and so on.

### 3. Problems

### 3.1. The Core Problem

The state-of-the-art image compression networks include an autoregressive model (for example the context model) to improve the compression performance. However autoregressive model is not suitable for parallelization, making the overall decoding process very slow, which significantly limits its application in real world.

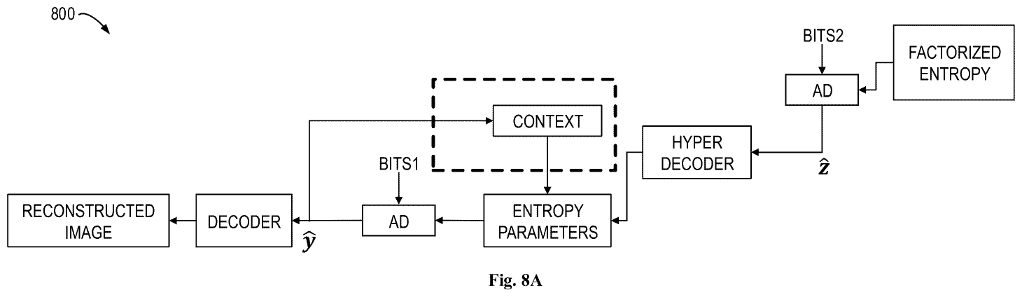

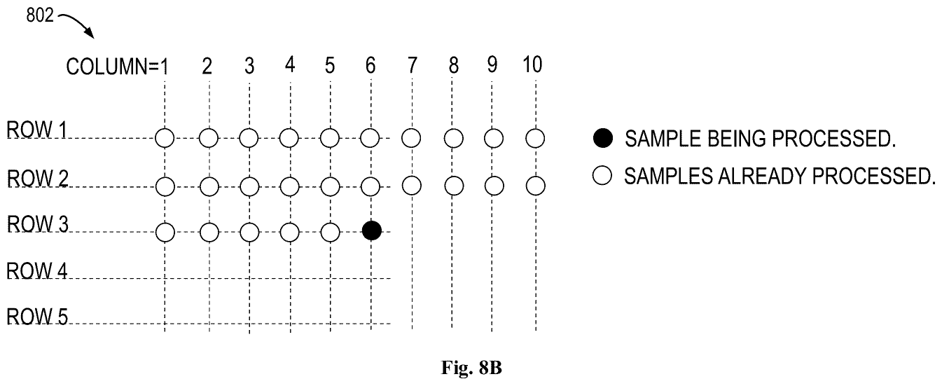

The problem pertains to the autoregressive subnetwork (context model) part of the state-of-the-art image decoding architecture. The FIG. 8A depicts the state-of-the-art decoder design. The modules on the right hand side, that are encapsulated in the dashed rectangle are responsible for autoregressive context modeling of the quantized latent ŷ. This part is very slow in state-of-the-art architectures due to the necessity of processing the samples of quantized latent serially in raster scan order. For example, when coding a 1080p sequence, it might need significantly more time than a parallelization-friendly system.

The problem is also described in an existing design as follows: “The downside is that the autoregressive model can only access codes in its causal context since the decoder runs serially in raster-scan order.”

FIG. 8B illustrates a raster scan processing order. According to raster scan processing order, samples in a row are processed from left to right. And rows are processed from top to bottom.

### 3.2. Details of the Problem

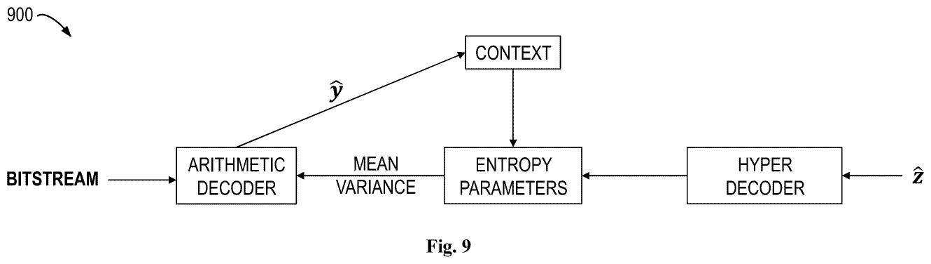

FIG. 9 illustrates an entropy coding part of the state-of-the-art decoding architecture. In the state-of-the-art image decoding architecture according to an existing design, the process of reconstructing the quantized latent ŷ is performed as follows:
1. The quantized hyper latent \hat{z} is processed by hyper decoder to generate a first partial information P_{hyper}.
2. The following operation is performed in raster scan order and in a recursive manner to reconstruct a sample of the quantized latent ŷ[i,j]:
   a. The context module generates second partial information P_{ctx} using the samples ŷ[m, n], wherein
      i. n<j, or
      ii. m<i if n is equal to j.
      (The samples located at [m, n] are the ones that are already reconstructed.)
   b. Using the first and the second partial information, the Entropy parameter module generates the μ[i,j] and σ[i,j], which are the mean and variance of gaussian probability distribution.
   c. Arithmetic decoder decodes the sample ŷ[i,j] from the bitstream using the probability distribution, whose mean and variance are μ[i,j] and σ[i,j].

After the quantized latent ŷ is reconstructed according to the above flow chart, it is processed by a synthesis transform (the decoder) to obtain the reconstructed picture. The synthesis transform is called decoder according to the notation used in FIG. 7. The whole process described above (that includes reconstruction of the ŷ and reconstruction of the image) is also called decoding or a decoder.

In the above a sample of quantized latent is denoted by ŷ[i,j]. It is noted that the sample is not necessarily a scalar value, it might be a vector and might contain multiple elements. In the rest of the application a sample can be denoted by ŷ[i,j] or ŷ[:, i,j]. In the latter, the “:” is used to denote that there is a third dimension and is used to stress that the sample has multiple elements.

After the samples of the quantized latent ŷ are reconstructed, the synthesis transform (i.e. decoder) is performed to obtain the reconstructed image.

As it is apparent from the above description, the auto-regressive subnetwork (context module) is responsible for the serial processing, as it requires already processed samples (i.e. quantized latent ŷ) as input, to generate the next sample ŷ[:, i,j]. More specifically, the step 2 in the above flowchart corresponds to the reconstruction of ŷ using a context model. At this step, the reconstruction of one sample depends on the previous neighboring samples, therefore a strict processing order, hence a serial operation is required.

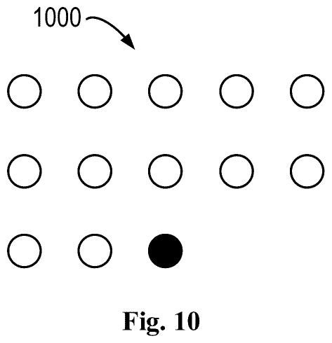

As an example, in an existing design, the context module utilizes 12 samples around the current ŷ[:, i,j], to generate the sample ŷ[:, i,j]. Those samples are depicted in FIG. 10 with empty circles. The sample ŷ[:, i,j] is depicted with filled circle.

FIG. 10 illustrates a kernel of context model in state of the art. As one can understand from FIG. 10, the processing of sample ŷ[:, i,j] requires that the samples ŷ[:, i−1,j], ŷ[:, i,j−1], ŷ[:, i−1,j−1],ŷ[:,i−2, j], ŷ[:, i−1,j−1], ŷ[:, i,j−2], ŷ[:, i−1,j −2], ŷ[:, i−2, j−2],ŷ[:, i+1, j−1], ŷ[:, i+1,j−1], ŷ[:, i+1,j−2], ŷ[:, i+2,j−2], (i.e. the 12 samples from the top-left two rows/columns) to be available and already constructed. This poses a strict processing order for the quantized latent. Typically, raster scan processing (starting from top-left sample, processing row by row, and left to right within a row) is employed, which results in serial processing of samples.

Due to the serial nature, the samples need to be processed one-by-one and therefore the encoding and decoding processes are extremely slow.

In other words, let the amount of computations in order to generate a sample ŷ[:, i,j] is N. This number N is typically smaller than the capacity of a contemporary GPU. Therefore, during the reconstruction of the ŷ, the available GPU resources cannot be fully utilized and hence stay idle. This is the reason why the reconstruction process is slow.

It is noted that the problem pertains to the decoder in the state-of-the-art image compression architectures with deep neural networks. The encoder does not suffer from the problem, since in the encoder the process flow is as follows:
1. First an analysis transform is applied to convert the input image x into latent y.
2. A quantization process is applied (denoted by Q in FIG. 6), to obtain all samples of ŷ.
3. For each sample of ŷ[i,j] a probability parameters (μ[i, j] and σ[i, j]) are calculated using the context model.
4. The probability parameters are used by the entropy encoding module to encode each sample of ŷ into a bitstream.

The operation of context module is not autoregressive in the encoder, since the output of the context model is not used as input later on. In other words, all of the samples of ŷ, which is the input of the context model are available after step 2, before the application of the context model.

### 4. Detailed Solutions

The detailed solutions below should be considered as examples to explain general concepts. These solutions should not be interpreted in a narrow way. Furthermore, these solutions can be combined in any manner.

### 4.1. Target of the Solution

The target of the solution is to speed up the processing by the autoregressive subnetwork (context model), and increase the utilization of the GPU resources. More specifically, instead of a raster scan processing order, a row-wise concurrent processing order is implemented, wherein the rows of quantized latent is reconstructed at the same time.

The complexity of the auto-regressive subnetwork increases proportional to the number of samples required for processing a current sample (the size of the processing kernel).

### 4.2. Core of the Solution

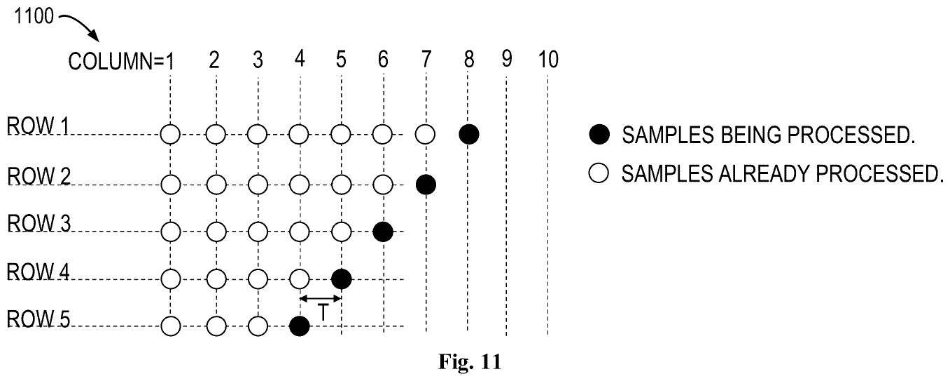

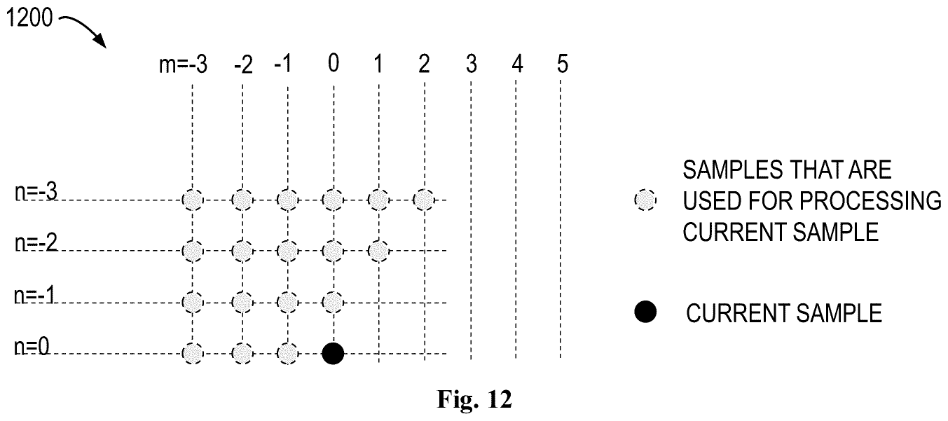

In the core of the solution, the kernel of the autoregressive subnetwork is designed in such a way that the multiple samples of the quantized latent can be processed at the same time as shown in FIGS. 11 and 12.

FIG. 11 illustrates the processing of the samples of the quantized latent. Multiple samples are processed at a given time instant.

FIG. 12 illustrates a processing kernel of the autoregressive network according to some embodiments of the present disclosure. The m and n indicate the relative coordinates of the samples required to process a current sample.

The solution can be explained with the help of FIGS. 11 and 12. In FIG. 12, a kernel that is used in the processing by the autoregressive subnetwork (e.g. context module) is depicted. In the FIG. 12, the solid filled block sample indicates the sample that is processed, and the grey filled samples indicate the samples in the vicinity of the current sample that are used for the processing of the current sample, the pair (n, m) determine the relative coordinate of the sample w.r.t. the current sample.

The kernel that is depicted in FIG. 12 makes it possible to process multiple samples of the quantized latent at the same time according to a pattern that is depicted in FIG. 11. In FIG. 11, the circles represent the samples that are already processed, and the black circles represent the samples that are currently being processed. In FIG. 11, it is assumed that the processing kernel in FIG. 12 is used, which is the reason that it is possible to process multiple samples according to the pattern in FIG. 11.

The kernel of the autoregressive subnetwork defines which samples in the vicinity of the current sample is required for the processing of the current sample. Processing of those required samples must be complete, otherwise they cannot be used by the subnetwork. In other words, a sample that is currently being processed cannot be used by the autoregressive subnetwork.

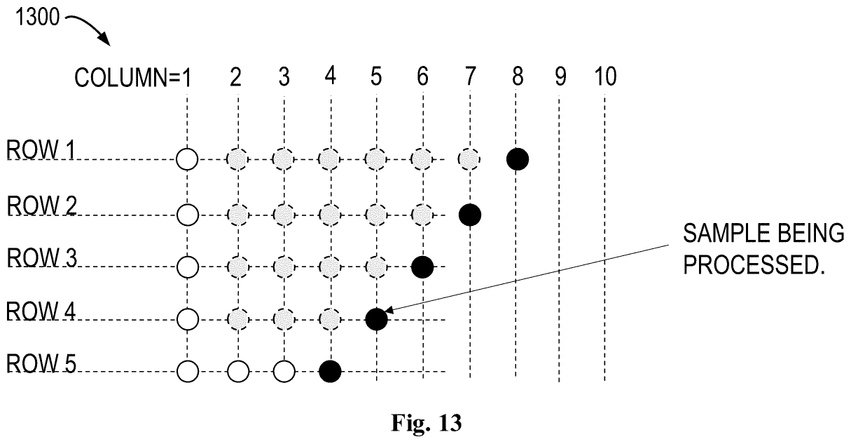

FIG. 13 illustrates the processing kernel shown in FIG. 12 in the context of processing of the samples of the quantized latent. More specifically, FIG. 13 depicts the kernel in FIG. 12 when it is overlayed on the FIG. 11. The kernel is overlayed on the sample that is marked with “Sample being processed”.

As one can see in FIG. 13, all the samples that are required for the processing of the black sample in Row 4 are available (are already processed). Therefore, it is possible to continue processing of this sample.

Similarly, if one overlays the kernel on the black sample in the fifth row, same observation can be made. All samples that are required for the processing of this sample are available, therefore this sample can be processed together with the sample in the 4^{th} row at the same time. In fact, one sample from each row can be processed at the same time.

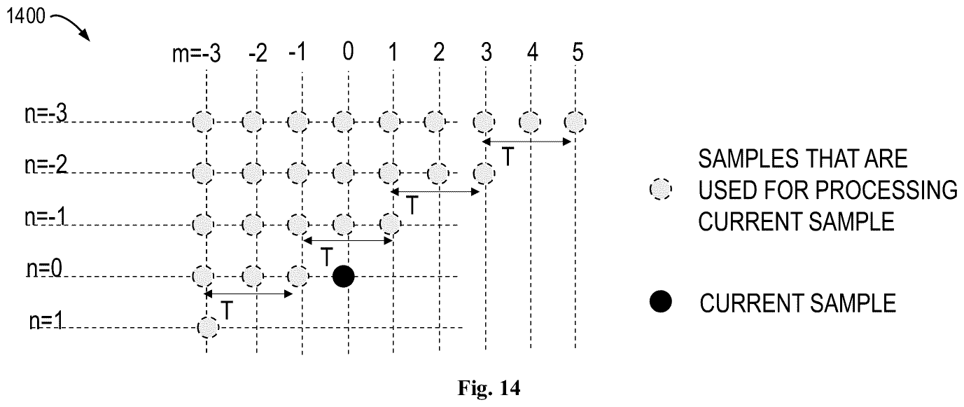

FIG. 14 illustrates a filter kernel that is used to process a current sample according to some embodiments of the present disclosure. The m and n indicate the relative coordinates of the samples required to process a current sample.

According to the solution different processing patterns and kernel shapes are possible. This can be explained with the help of the FIGS. 13 and 14. FIG. 14 exemplifies a filter kernel shape, wherein the samples used for processing follow a diagonal pattern on the right hand side. This shape can be defined by the value T, which the distance between the last sample of a sample row and the next row. In the FIG. 14, the T is equal to 2, in other words a row of “required samples” of the kernel ends 2 samples before compared to the row of samples above it.

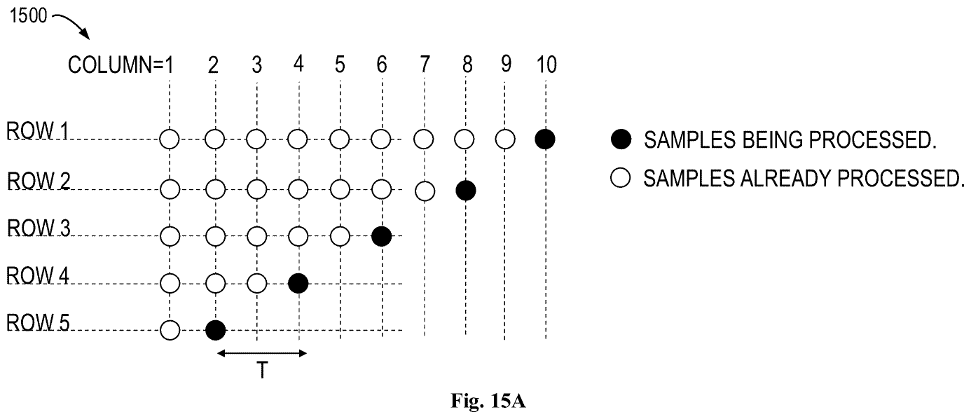

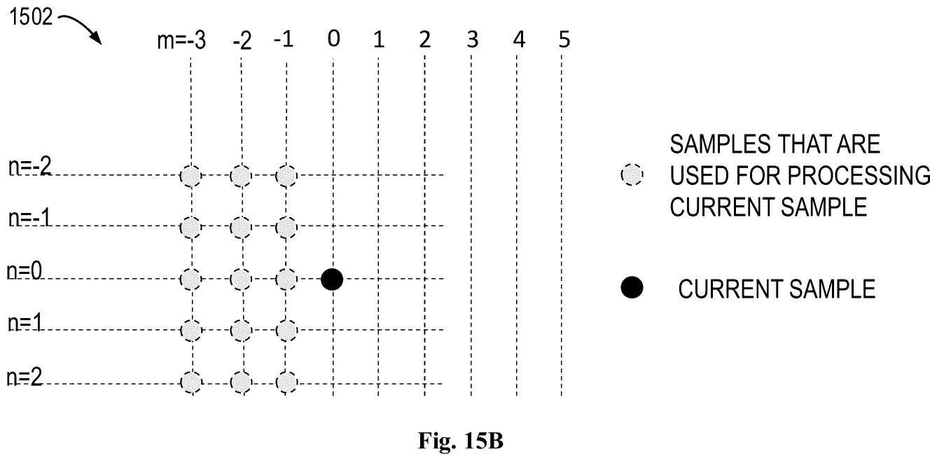

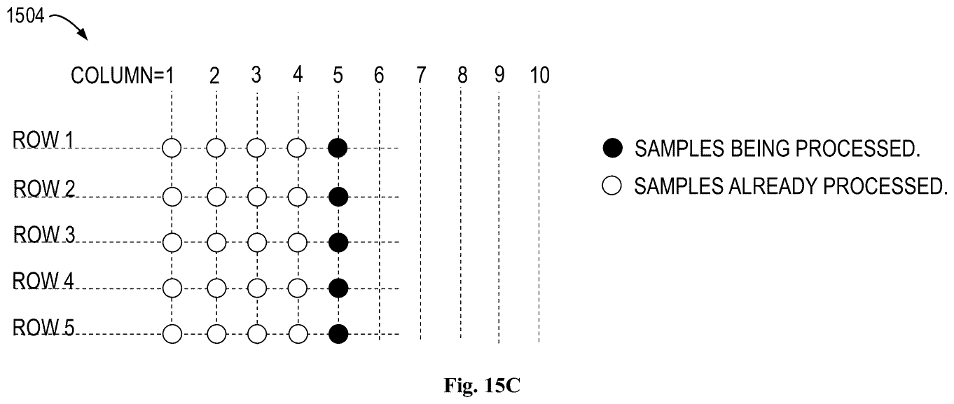

If the filter kernel in FIG. 14 is used, one can process the rows of the latent using the pattern shown in FIG. 15A. FIG. 15A illustrates a processing pattern of the quantized latent ŷ according to some embodiments of the present disclosure. In FIG. 15A, one sample form each sample row can be processed at a time instant, given that it has a “delay” of T samples compared to the row above. The condition of delaying the processing T samples in each consecutive sample row guarantees that samples required for processing of all current samples are available. If one overlays the filter kernel centered around any one of the currently processed samples, all samples required for processing the current sample must have already been processed. The value of T and the size of the quantized latent determine the number of samples of the quantizes latent that can be processed concurrently. For example if the T is large, the number of samples that can be processed concurrently is reduced. If T is equal to 3 and the width of the quantized latent is 30 samples for example, maximum of 30/3=10 samples can be processed concurrently. On the other hand if T is selected as 1, maximum of 30/1=30 samples can be processed concurrently. If T is equal to 0, all rows of the quantized latent can be processed concurrently. FIGS. 15B and 15C illustrates the kernel shape and the corresponding processing pattern where T=0 according to some embodiments of the present disclosure. As shown in FIG. 15C, all rows of the quantized latent can be processed concurrently. The solution provides the possibility of concurrently processing multiple samples. As a result, implementations that are capable of processing multiple samples can take advantage of the solution. On the other hand, the solution does not prohibit processing a single sample at a time.

### 4.3. Details of the Solution

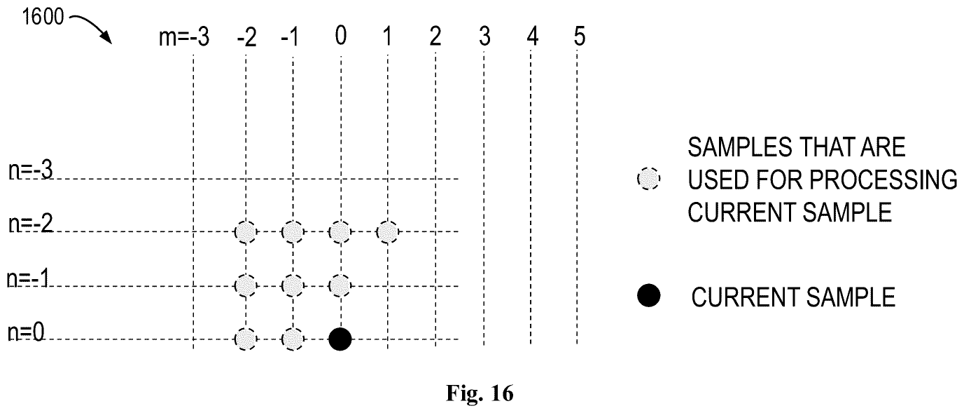

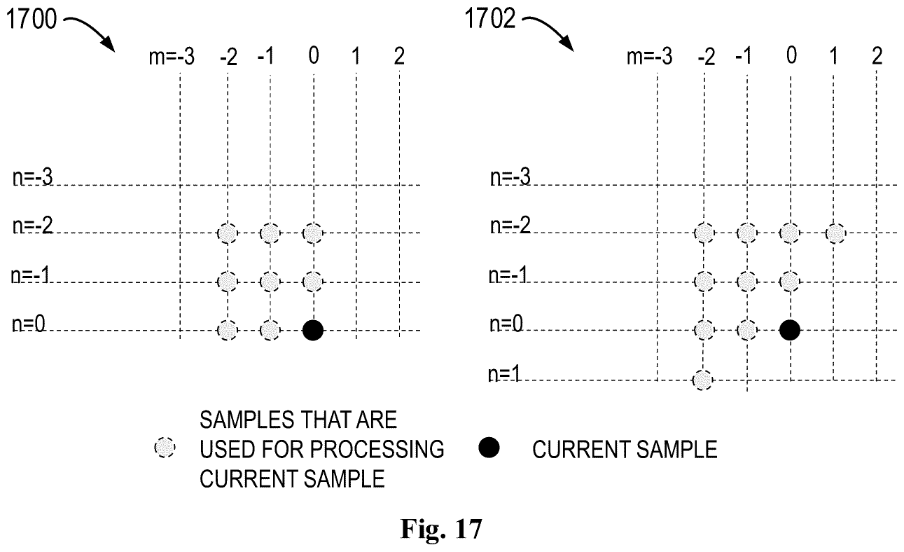

1. To handle boundaries of the quantized latent, padding might be applied to generate at least one unavailable sample for processing. For example in FIG. 15A, the processing of the current sample at the top row (whose position is row 1, column 10) might require samples above it. Those missing samples at the boundaries of the quantized latent can be obtained by means of padding, sample replication or some other boundary processing method.
   a. In one example, an unavailable sample may be padded with a fixed value, such as 0.
   b. In one example, an unavailable sample may be padded with the value of the nearest available sample.
   c. In one example, an unavailable sample may be generated by the mirror padding.
   d. In one example, an unavailable sample may be generated by the circular padding.
2. According to the solution, the samples of the quantized latent can be processed row by row.
   a. Alternatively, or the samples of the quantized latent can be processed column by column.
   b. Alternatively, transposing processing (exchanging rows with columns) may be applied before the process.
3. In order to reduce the complexity, it is proposed to impose additional restriction(s) on the number of samples in the processing kernel. For example if T is equal to 1, one can impose the following restrictions:
   a. −2<=m<=1;
   b. −2<=n<=0.
   In this case the processing kernel shown in FIG. 16 is obtained according to the solution.
4. According to the solution, additional restriction(s) can be imposed on the shape of the processing kernel as “n<=0”. This additional restriction guarantees both “concurrent processing of multiple samples” and “raster scan processing” are possible. Raster scan processing is exemplified in FIG. 8B. If for example an implementation of the auto-regressive network can process only one sample at a time, then it can fall back to the original raster scan processing.
5. According to the solution, additional restriction(s) can be applied on the shape of the processing kernel such that it is symmetric around the diagonal axis that passes through the current sample. The FIG. 17 exemplify the filter kernels according to the additional restriction. The additional restriction guarantees that both column by column and row by row concurrent processing is possible at the same time.
   FIG. 17 illustrates exemplary symmetric filter kernels according to some embodiments of the present disclosure. The filter kernels are symmetric around the diagonal axis that passes through the current sample. In both examples T is equal to 1.
6. It is required that a latent sample can only depend on a set of neighboring samples in the decoding process.
   a. The set of neighboring samples may be determined based on the position of the current sample.
   b. Examples of sets of neighboring samples are shown in FIG. 15A-FIG. 17.
7. In one example, whether to/how to apply the proposed multiple-sample concurrency processing method may be signaled from the encoder to the decoder.
   a. For example, T may be signaled from the encoder to the decoder.
   b. For example, the information of the set of neighboring samples that can be depended by a sample may be signaled.
8. In one example, a latent image may be partitioned into multiple regions (such as slices or tiles), which can be processed independently.

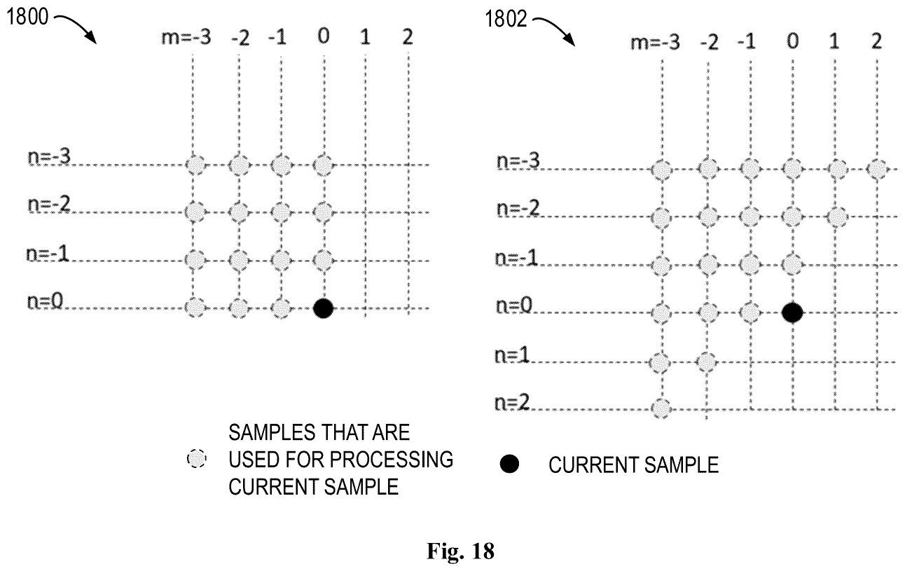

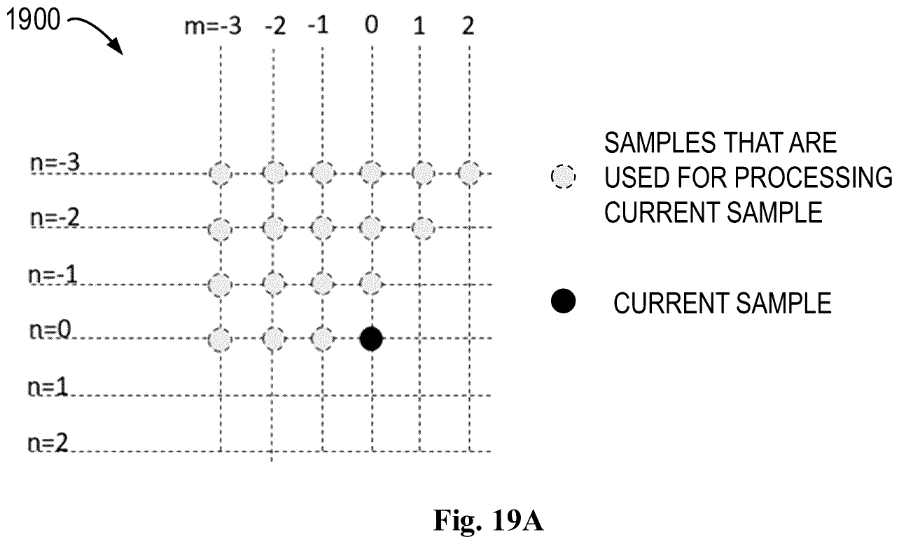

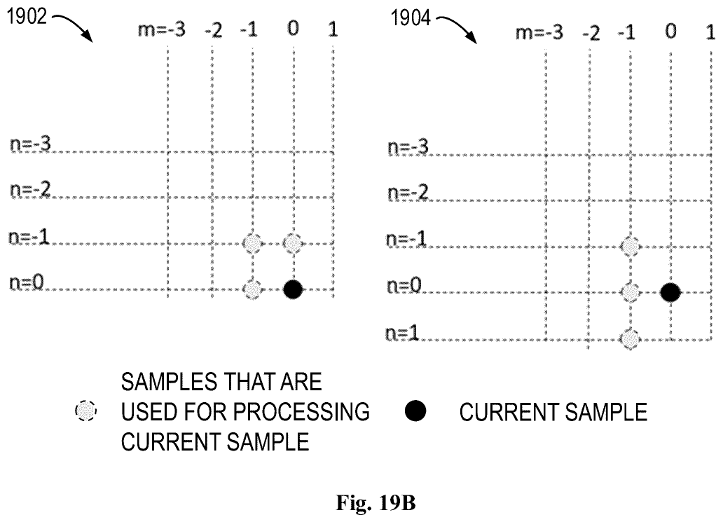

Some further specific implementation examples of the solution are presented in FIG. 18 and FIGS. 19A-19B:

FIG. 18 illustrates further exemplary symmetric filter kernels according to some embodiments of the present disclosure. The filter kernels are symmetric around the diagonal axis that passes through the current sample. In both examples T is equal to 1. On the left −3<=m<=0 and −3<=n<=0, on the right −3<=m<=2 and −3<=n<=2.

FIG. 19A illustrates another example processing kernel according to some embodiments of the present disclosure, where when T=1, −3<=m<=2 and −3<=n<=0.

FIG. 19B illustrates a further example processing kernel according to some embodiments of the present disclosure. On the left T=1, −1<=m<=0 and −1<=n<=0, on the right T=0, m=−1 and −1<=n<=1.

### 4.4. The Difference Between the State of the Art and the Solution

The state of art processing kernel is depicted in FIG. 10. One can obtain this kernel setting T=3 and additionally requiring abs(n)<=2 and abs (m)<=2. However the state of the art only mentions raster scan processing pattern (only one sample at a time).

If the solution is applied with the kernel in the state of the art, it is possible to process one sample from each row of the quantized latent with a “delay” of 3 samples. The delay of 3 samples is however not very efficient, especially considering the fact that typical graphical processing units comprise thousands of cores. For example if the width of the quantized latent is 30 samples, only 30/3=10 samples can be processed concurrently. In such a scenario it might not be possible to fully utilize the capacity of a modern GPU.

Additionally the solution provides also more efficient processing kernels. In a preferred implementation of the solution T is equal to 2, 1 or 0.

### 4.5. Benefit of the Solution

The solution provides a method of concurrently processing samples in order to speed up processing with an auto-regressive subnetwork. Additionally multiple kernel shapes are provided for more efficient and faster processing.

### 5. Embodiments

1. An image decoding method, comprising the steps of:
Obtaining all samples of a quantized latent applying the following steps recursively;
   Obtaining a first set of probability parameters using already reconstructed samples of ŷ[i+m,j+n] using an autoregressive subnetwork.
   Obtaining a second set of probability parameters using already reconstructed samples of ŷ[k+m, l+n] using the autoregressive neural subnetwork.
   Using the first and second probability parameter sets to obtain a new samples ŷ[i,j] and ŷ[k, l] respectively.
Wherein all indices (i, j, k, l, m, n) are integers,
Obtaining the reconstructed image using the quantized latent ŷ and a synthesis transform subnetwork.

2. According to embodiment 1,
k=i+1 and l=j−T is satisfied, wherein T is a non-negative integer.

3. According to embodiment 2,

The pairs of (m, n) satisfy the following:
m<0−T×n and n≤0.

4. According to embodiment 1,
k=i−T and l=j+1 is satisfied, wherein T is a non-negative integer.

5. According to embodiment 4,
The pairs of (m, n) satisfy the following:
n<0−T×m and m≤0.

6. According to all embodiments above,
T is equal to 1.

7. According to embodiment 6, the pairs of (m, n) have the following values:
(0,−1), (0,−2), (−1,0), (−,1, (−1,−2), (−2,1), (−2,0), (−2,−1), (−2,−2).

8. According to all embodiments above,
T is equal to 0.

9. According to embodiment 8, the pairs of (m, n) have the following values:
(0,−1), (0,−2), (−,1, (−1,−2), (−2,−1), (−2,−2), (1,−1), (1,−2), (2,−1), (2,−2).

10. According to all embodiments above,
T is equal to 2.

11. According to all embodiments above,
T is a non-negative integer that is signalled in the bitstream.

12. According to embodiment 11,
At least 2 different autoregressive subnetworks is used, and value of T determines which autoregressive network is used.

13. According to any of the embodiments above,
m or n satisfy the following:
abs(m)<M or abs(n)<N.

14. According to embodiment 13,
M=2 andN=2.

15. According to embodiment 13,
M=1 andN=1.

16. According to embodiment 13,
M=3 andN=3.

17. According to any of the embodiments above,
m or n satisfy the following:
m≤0 or n≤0.

18. According to any of the embodiments above,
m or n satisfy the following:
m≤0 or n≤0.

19. According to any of the embodiments above,
The test comprising all of the pairs of (m, n) of the filter kernel satisfies the following:
Corresponding to each pair (a, b) in the set, there is another pair (b, a).

More details of the embodiments of the present disclosure will be described below which are related to neural network-based data coding. As used herein, the term “data” may refer to an image, a picture in a video, or any other data suitable to be coded.

As discussed above, the existing image compression networks include an autoregressive model (e.g., the context model) to improve the compression performance. However, the auto-regressive subnetwork is responsible for the serial processing, as it requires already processed samples as input to generate the next sample. Due to this serial nature, the samples need to be processed one-by-one and therefore the coding processes are extremely slow.

To solve the above problems and some other problems not mentioned, data processing solutions as described below are disclosed. The embodiments of the present disclosure should be considered as examples to explain the general concepts and should not be interpreted in a narrow way. Furthermore, these embodiments can be applied individually or combined in any manner.

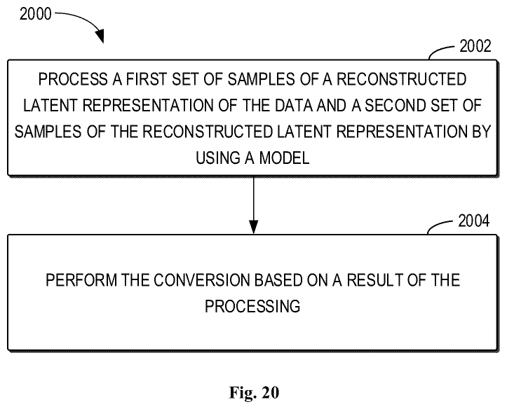

FIG. 20 illustrates a flowchart of a method 2000 for data processing in accordance with some embodiments of the present disclosure. The method 2000 may be implemented during a conversion between the data and a bitstream of the data. As shown in FIG. 20, the method 2000 starts at 2002, a first set of samples of a reconstructed latent representation of the data and a second set of samples of the reconstructed latent representation are processed by using a model. The first set of samples are associated with a first sample of the reconstructed latent representation and the second set of samples are associated with a second sample of the reconstructed latent representation. The first set of samples and the second set of samples may be processed in parallel. In other words, the model processes the first set of samples and the second set of samples concurrently. In some embodiments, the reconstructed latent representation may be a quantized latent representation of the data.

For purpose of illustration, the proposed method will be discussed with respect to the first sample, which may also be referred to as a current sample hereinafter. It should be understood that the second sample may be process in a way similar to the first sample. The first set of samples may comprise a plurality of neighboring samples of the first sample. In one example, the first set of samples may be adjacent to the first sample. In another example, at least one sample in the first set of samples may be non-adjacent to the first sample. Alternatively, the first set of samples may also comprise only one sample. In a further example, the first set of samples may be determined based on a position of the first sample. Additionally, information on the first set of samples may be indicated in the bitstream.

With reference to FIG. 12, the first set of samples comprises the gray filled samples, i.e., the samples that are used for processing the current sample. It should be understood that the first set of samples may also comprises any other suitable samples of the reconstructed latent representation. The scope of the present disclosure is not limited in this respect.

In some embodiments, the model may comprise a neural subnetwork. Alternatively, the model may be a neural subnetwork. By way of example rather than limitation, the neural subnetwork may be autoregressive. In one example, the neural subnetwork may be a context model subnetwork, a context subnetwork, a context model, or the like.

It should be understood the first set of samples are processed to reconstruct the first sample. As such, the first sample may also be referred to as being processed, when the first set of samples are being processed. Similarly, the second sample may also be referred to as being processed, when the second set of samples are being processed.

At 2004, the conversion is performed based on a result of the processing. By way of example rather than limitation, the first set of samples and the second set of samples may be processed by the model to generate partial information for the first sample and the second sample. And the conversion may be performed based on the partial information. In one example, the conversion may include encoding the data into the bitstream. Alternatively or additionally, the conversion may include decoding the data from the bitstream. It should be understood that the above illustrations are described merely for purpose of description. The scope of the present disclosure is not limited in this respect.

In view of the foregoing, the first set of samples and the second set of samples are processed in parallel by the model. Compared with the conventional solution where the first set of samples and the second set of samples are processed in serial, the proposed method can advantageously speed up the processing, and thus the coding efficiency can be improved.

In some embodiments, the first sample may be at i-th row and j-th column of the reconstructed latent representation and the second sample may be at p-th row and q-th column of the reconstructed latent representation. Each of i, j, p and q may be an integer. In one example, p=i+1 and q=j−T. T may be referred to as a wave shift, and is a non-negative integer, e.g., 0, 1, 2, etc. That is, the second sample is at a row adjacent to the first sample, and wave shift T represents a difference between column indexes of the first sample and the second sample. In another example, p=i−T and q=j+1, where T is non-integer. In such a case, the second sample is at a column adjacent to the first sample, and T represents a difference between row indexes of the first sample and the second sample. In some embodiments, T may be indicated in the bitstream and signaled from an encoder to a decoder.

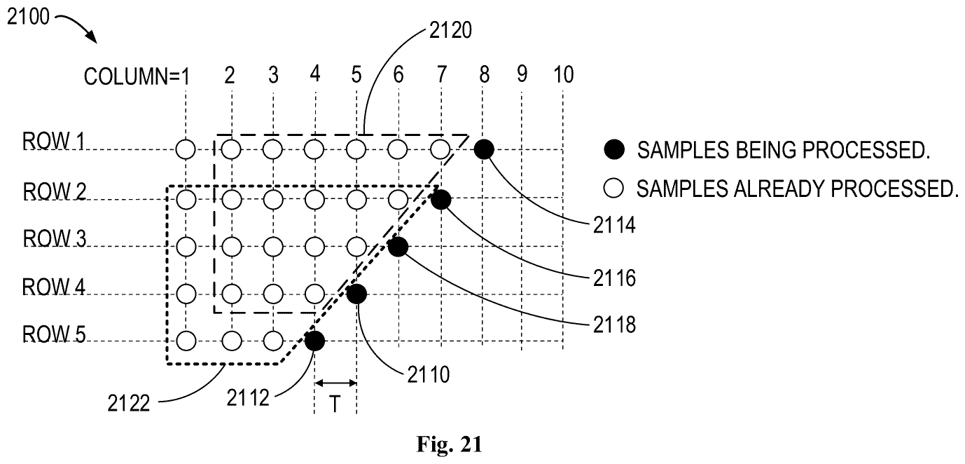

By way of example rather than limitation, FIG. 21 illustrates an example processing pattern according to some embodiments of the present disclosure. As shown in FIG. 21, the first sample 2110 is located at the 4^{th} row and 5^{th} column of the reconstructed latent representation. The second sample 2112 is located at the 5^{th} row and the 4^{th} column of the reconstructed latent representation and the wave shift T is equal to 1.

It is assumed that the processing kernel shown in FIG. 12 is employed. Samples contained in the dashed box 2120 correspond to the first set of samples for the first sample, and samples contained in the dashed box 2122 correspond to the second set of samples for the second sample. It is seen that, the first set of samples does not comprise the second sample, and the second set of samples does not comprise the first sample, which enables the parallelization of the processing of the first set of samples and the second set of samples.

As shown in FIG. 21, the samples 2110, 2112, 2114, 2116 and 2118 may be processed in parallel due to the kernel shape of the processing kernel shown in FIG. 12. Thereby, the processing speed of samples of the reconstructed latent representation may be significantly improved.

In some embodiments, the first set of samples may comprise a sample at (i+m)-th row and (j+n)-th column of the reconstructed latent representation. Each of m and n may be an integer. In one example, m and n satisfy: −2<=m<=1 and −2<=n<=0. One example processing kernel satisfies this requirement is shown in FIG. 16. As shown in FIG. 16, pairs of (m, n) have the following values: (1, −2), (0, −1), (0, −2), (−1, 0), (−1, −1), (−1, −2), (−2, 0), (−2, −1), and (−2, −2). An example processing pattern utilizing such a processing kernel may have the wave shift T being equal to 1.

In some embodiments, an additional restriction that n is smaller than or equal to 0 may be applied to the kernel shape. The processing kernel 1700 in FIG. 17 illustrates an example processing kernel satisfying such a restriction. It is seen that a processing kernel can advantageously support both “concurrent processing of samples” and “raster scan processing”, which make it possible for the encoder and/or decoder to switch the processing pattern. In addition, a further additional restriction that m is smaller than or equal to 0 may be applied to the kernel shape.

In some embodiments, it may be required that m<0−T x n and n<=0. Alternatively, it may be required that m<=0 and n<0−T x m. In some embodiments, an additional restriction that −3<=m<=0 and −3<=n<=0 may be applied to the kernel shape. The processing kernel 1800 in FIG. 18 illustrates an example processing kernel satisfying such a restriction. In some embodiments, an additional restriction that −3<=m<=2 and −3<=n<=2 may be applied to the kernel shape. The processing kernel 1802 in FIG. 18 illustrates an example processing kernel satisfying such a restriction. In some embodiments, an additional restriction that −1<=m<=0 and −1<=n<=0 may be applied to the kernel shape. The processing kernel 1902 in FIG. 19B illustrates an example processing kernel satisfying such a restriction. In some embodiments, an additional restriction that m=−1 and −1<=n<=1 may be applied to the kernel shape. The processing kernel 1902 in FIG. 19B illustrates an example processing kernel satisfying such a restriction.

In some embodiments, an absolute value of m may be smaller than or equal to M, an absolute value of n may be smaller than or equal to N. Each of M and N may be a non-negative integer. In one example, M is equal to 2 and N is equal to 2. Alternatively, M is equal to 1 and N is equal to 1. In a further example, M is equal to 3 and N is equal to 3.

The value of T and the size of the reconstrued latent representation determine the number of samples that can be processed concurrently. For example if the T is large, the number of samples that can be processed concurrently is reduced. If T is equal to 3 and the width of the reconstrued latent representation is 30 samples for example, maximum of 30/3=10 samples can be processed concurrently. On the other hand if T is selected as 1, maximum of 30/1=30 samples can be processed concurrently. If T is equal to 0, all rows of the reconstrued latent representation can be processed concurrently and thus the processing speed of samples of the reconstructed latent representation may be significantly improved. In some embodiments, the wave shift T may be equal to 0. Pairs of (m, n) have the following values: (0, −1), (0, −2), (−1, 0), (−1, −1), (−1, −2), (−2, 0), (−2, −1), and (−2, −2). Alternatively, pairs of (m, n) have the following values: (−1, 2), (−1, 1), (−1, 0), (−1,−1), (−1, −2), (−2, 2), (−2, 1), (−2, 0), (−2,−1), (−2, −2), (−3, 2), (−3, 1), (−3, 0), (−3,−1), (−3, −2), and (−3, 2).

In some embodiments, if a third sample of the first set of samples is unavailable, for example the third sample is located outside of the boundaries of the reconstructed latent representation, a value of the third sample may be obtained by means of padding, sample replication, or any other suitable boundary processing method. In one example, the value of the third sample may be set to be a fixed value. Alternatively, the value of the third sample may be set to be a value of the nearest available sample of the third sample. In another example, the value of the third sample may be generated by a mirror padding or a circular padding. It should be understood that the above examples are described merely for purpose of description. The scope of the present disclosure is not limited in this respect.

In some embodiments, samples of the reconstructed latent representation may be processed row by row. Alternatively, samples of the reconstructed latent representation may be processed column by column. In addition, a transposing process may be applied on the reconstructed latent representation before the processing.

In some embodiments, the following additional restriction may be applied: a shape of a processing kernel for processing the first sample shall be symmetric around a diagonal axis passing through the first sample. The processing kernels (also referred to as a filter kernel) 1700 and 1702 shown in FIG. 17 satisfy the above additional restriction. In aid of this additional restriction, both column by column and row by row concurrent processing is possible at the same time.

In some embodiments, information on at least one of the following may be indicated in the bitstream: whether to process a plurality of samples of the reconstructed latent representation in parallel, or how to process the plurality of samples in parallel. In some embodiments, the reconstructed latent representation may be partitioned into a plurality of regions, and the plurality of regions may be processed independently.

According to embodiments of the present disclosure, a non-transitory computer-readable recording medium is proposed. A bitstream of data is stored in the non-transitory computer-readable recording medium. The bitstream can be generated by a method performed by a data processing apparatus. According to the method, a first set of samples of a reconstructed latent representation of the data and a second set of samples of the reconstructed latent representation is processed by using a model. The first set of samples are associated with a first sample of the reconstructed latent representation and the second set of samples are associated with a second sample of the reconstructed latent representation. Moreover, the bitstream is generated based on a result of the processing.

According to embodiments of the present disclosure, a method for storing a bitstream of data is proposed. In the method, a first set of samples of a reconstructed latent representation of the data and a second set of samples of the reconstructed latent representation is processed by using a model. The first set of samples are associated with a first sample of the reconstructed latent representation and the second set of samples are associated with a second sample of the reconstructed latent representation. Moreover, the bitstream is generated based on a result of the processing and the bitstream is stored in the non-transitory computer-readable recording medium.

Implementations of the present disclosure can be described in view of the following clauses, the features of which can be combined in any reasonable manner.

Clause 1. A method for data processing, comprising: processing, during a conversion between data and a bitstream of the data, a first set of samples of a reconstructed latent representation of the data and a second set of samples of the reconstructed latent representation by using a model, the first set of samples being associated with a first sample of the reconstructed latent representation and the second set of samples being associated with a second sample of the reconstructed latent representation; and performing the conversion based on a result of the processing.

Clause 2. The method of clause 1, wherein the first set of samples and the second set of samples are processed in parallel.

Clause 3. The method of any of clauses 1−2, wherein the first set of samples does not comprise the second sample, and the second set of samples does not comprise the first sample.

Clause 4. The method of any of clauses 1−3, wherein the model comprises a neural subnetwork.

Clause 5. The method of clause 4, wherein the neural subnetwork is autoregressive.

Clause 6. The method of any of clauses 4−5, wherein the neural subnetwork comprises a context model subnetwork or a context subnetwork.

Clause 7. The method of any of clauses 1−6, wherein the first sample is at i-th row and j-th column of the reconstructed latent representation, the second sample is at p-th row and q-th column of the reconstructed latent representation, and each of i, j, p and q is an integer.

Clause 8. The method of clause 7, wherein p=i+1 and q=j−T, and T represents a difference between column indexes of the first sample and the second sample and is a non-negative integer.

Clause 9. The method of clause 7, wherein p=i−T and q=j+1, and T represents a difference between row indexes of the first sample and the second sample and is a non-negative integer.

Clause 10. The method of any of clauses 8−9, wherein T is equal to 0, 1, or 2.

Clause 11. The method of any of clauses 8−10, wherein T is indicated in the bitstream.

Clause 12. The method of any of clauses 7−11, wherein the first set of samples comprise a sample at (i+m)-th row and (j+n)-th column of the reconstructed latent representation, and each of m and n is an integer.

Clause 13. The method of clause 12, wherein −2<=m<=1 and −2<=n<=0.

Clause 14. The method of any of clauses 12−13, wherein T is equal to 1, and pairs of (m, n) have the following values: (1, −2), (0, −1), (0, −2), (−1, 0), (−1, −1), (−1, −2), (−2, 0), (−2, −1), and (−2, −2).

Clause 15. The method of clause 12, wherein n is smaller than or equal to 0.

Clause 16. The method of clause 12, wherein m<0−T x n and n<=0, or m<=0 and n<0−T x m, or m<=0 and n<=0, or −3<=m<=0 and −3<=n<=0, or −3<=m<=2 and −3<=n<=2, or −1<=m<=0 and −1<=n<=0, or m=−1 and −1<=n<=1.

Clause 17. The method of clause 12, wherein an absolute value of m is smaller than or equal to M, an absolute value of n is smaller than or equal to N, and each of M and N is a non-negative integer.

Clause 18. The method of clause 17, wherein M is equal to 2 and N is equal to 2, or M is equal to 1 and N is equal to 1, or M is equal to 3 and N is equal to 3.

Clause 19. The method of clause 12, wherein T is equal to 0, and pairs of (m, n) have the following values: (0, −1), (0, −2), (−1, 0), (−1, −1), (−1, −2), (−2, 0), (−2, −1), and (−2, −2).

Clause 20. The method of clause 12, wherein T is equal to 0, and pairs of (m, n) have the following values: (−1, 2), (−1, 1), (−1, 0), (−1,−1), (−1, −2), (−2, 2), (−2, 1), (−2, 0), (−2,−1), (−2, −2), (−3, 2), (−3, 1), (−3, 0), (−3,−1), (−3, −2), and (−3, 2).

Clause 21. The method of any of clauses 1−20, wherein if a third sample of the first set of samples is unavailable, a value of the third sample is obtained by means of padding or sample replication.

Clause 22. The method of clause 21, wherein the value of the third sample is set to be one of: a fixed value, or a value of the nearest available sample of the third sample.

Clause 23. The method of clause 21, wherein the value of the third sample is generated by a mirror padding or a circular padding.

Clause 24. The method of any of clauses 1−23, wherein samples of the reconstructed latent representation are processed row by row or column by column.

Clause 25. The method of clause 24, wherein a transposing process is applied on the reconstructed latent representation before the processing.

Clause 26. The method of any of clauses 1−13, wherein a shape of a processing kernel for processing the first sample is symmetric around a diagonal axis passing through the first sample.

Clause 27. The method of any of clauses 1−26, wherein the first set of samples are neighboring samples of the first sample.

Clause 28. The method of clause 27, wherein the first set of samples are determined based on a position of the first sample.

Clause 29. The method of any of clauses 1−28, wherein information on at least one of the following is indicated in the bitstream: whether to process a plurality of samples of the reconstructed latent representation in parallel, or how to process the plurality of samples in parallel.

Clause 30. The method of any of clauses 1−29, wherein information on the first set of samples is indicated in the bitstream.

Clause 31. The method of any of clauses 1−30, wherein the reconstructed latent representation is partitioned into a plurality of regions, and the plurality of regions are processed independently.

Clause 32. The method of any of clauses 1−31, wherein the reconstructed latent representation is a quantized latent representation of the data.

Clause 33. The method of any of clauses 1−32, wherein the data comprise a picture of a video or an image.

Clause 34. The method of any of clauses 1−33, wherein the conversion includes encoding the data into the bitstream.

Clause 35. The method of any of clauses 1−33, wherein the conversion includes decoding the data from the bitstream.

Clause 36. An apparatus for processing data comprising a processor and a non-transitory memory with instructions thereon, wherein the instructions upon execution by the processor, cause the processor to perform a method in accordance with any of clauses 1−35.

Clause 37. A non-transitory computer-readable storage medium storing instructions that cause a processor to perform a method in accordance with any of clauses 1−35.

Clause 38. A non-transitory computer-readable recording medium storing a bitstream of data which is generated by a method performed by a data processing apparatus, wherein the method comprises: processing a first set of samples of a reconstructed latent representation of the data and a second set of samples of the reconstructed latent representation by using a model, the first set of samples being associated with a first sample of the reconstructed latent representation and the second set of samples being associated with a second sample of the reconstructed latent representation; and generating the bitstream based on a result of the processing.

Clause 39. A method for storing a bitstream of data, comprising: processing a first set of samples of a reconstructed latent representation of the data and a second set of samples of the reconstructed latent representation by using a model, the first set of samples being associated with a first sample of the reconstructed latent representation and the second set of samples being associated with a second sample of the reconstructed latent representation; generating the bitstream based on a result of the processing; and storing the bitstream in a non-transitory computer-readable recording medium.

### Example Device

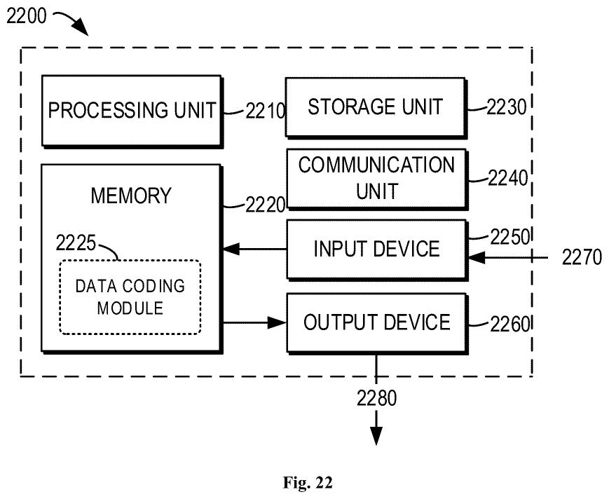

FIG. 22 illustrates a block diagram of a computing device 2200 in which various embodiments of the present disclosure can be implemented. The computing device 2200 may be implemented as or included in the source device 110 (or the data encoder 114) or the destination device 120 (or the data decoder 124).

It would be appreciated that the computing device 2200 shown in FIG. 22 is merely for purpose of illustration, without suggesting any limitation to the functions and scopes of the embodiments of the present disclosure in any manner.

As shown in FIG. 22, the computing device 2200 includes a general-purpose computing device 2200. The computing device 2200 may at least comprise one or more processors or processing units 2210, a memory 2220, a storage unit 2230, one or more communication units 2240, one or more input devices 2250, and one or more output devices 2260.

In some embodiments, the computing device 2200 maybe implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2200 can support any type of interface to a user (such as “wearable” circuitry and the like).

The processing unit 2210 may be a physical or virtual processor and can implement various processes based on programs stored in the memory 2220. In a multi-processor system, multiple processing units execute computer executable instructions in parallel so as to improve the parallel processing capability of the computing device 2200. The processing unit 2210 may also be referred to as a central processing unit (CPU), a microprocessor, a controller or a microcontroller.

The computing device 2200 typically includes various computer storage medium. Such medium can be any medium accessible by the computing device 2200, including, but not limited to, volatile and non-volatile medium, or detachable and non-detachable medium. The memory 2220 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2230 may be any detachable or non-detachable medium and may include a machine-readable medium such as a memory, flash memory drive, magnetic disk or another other media, which can be used for storing information and/or data and can be accessed in the computing device 2200.

The computing device 2200 may further include additional detachable/non-detachable, volatile/non-volatile memory medium. Although not shown in FIG. 22, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2240 communicates with a further computing device via the communication medium. In addition, the functions of the components in the computing device 2200 can be implemented by a single computing cluster or multiple computing machines that can communicate via communication connections. Therefore, the computing device 2200 can operate in a networked environment using a logical connection with one or more other servers, networked personal computers (PCs) or further general network nodes.

The input device 2250 may be one or more of a variety of input devices, such as a mouse, keyboard, tracking ball, voice-input device, and the like. The output device 2260 may be one or more of a variety of output devices, such as a display, loudspeaker, printer, and the like. By means of the communication unit 2240, the computing device 2200 can further communicate with one or more external devices (not shown) such as the storage devices and display device, with one or more devices enabling the user to interact with the computing device 2200, or any devices (such as a network card, a modem and the like) enabling the computing device 2200 to communicate with one or more other computing devices, if required. Such communication can be performed via input/output (I/O) interfaces (not shown).

In some embodiments, instead of being integrated in a single device, some or all components of the computing device 2200 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2200 may be used to implement data encoding/decoding in embodiments of the present disclosure. The memory 2220 may include one or more data coding modules 2225 having one or more program instructions. These modules are accessible and executable by the processing unit 2210 to perform the functionalities of the various embodiments described herein.

In the example embodiments of performing data encoding, the input device 2250 may receive data as an input 2270 to be encoded. The data may be processed, for example, by the data coding module 2225, to generate an encoded bitstream. The encoded bitstream may be provided via the output device 2260 as an output 2280.

In the example embodiments of performing data decoding, the input device 2250 may receive an encoded bitstream as the input 2270. The encoded bitstream may be processed, for example, by the data coding module 2225, to generate decoded data. The decoded data may be provided via the output device 2260 as the output 2280.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for data processing, comprising:
processing, during a conversion between data and a bitstream of the data, a first set of samples of a reconstructed latent representation of the data and a second set of samples of the reconstructed latent representation by using a model, the first set of samples being associated with a first sample of the reconstructed latent representation and the second set of samples being associated with a second sample of the reconstructed latent representation; and
performing the conversion based on a result of the processing.

2. The method of claim 1, wherein the first set of samples and the second set of samples are processed in parallel.

3. The method of claim 1, wherein the first set of samples does not comprise the second sample, and the second set of samples does not comprise the first sample.

4. The method of claim 1, wherein the model comprises a neural subnetwork.

5. The method of claim 4, wherein the neural subnetwork is autoregressive.

6. The method of claim 4, wherein the neural subnetwork comprises a context model subnetwork or a context subnetwork.

7. The method of claim 1, wherein the first sample is at i-th row and j-th column of the reconstructed latent representation, the second sample is at p-th row and q-th column of the reconstructed latent representation, and each of i, j, p and q is an integer.

8. The method of claim 7, wherein p=i+1 and q=j−T, and T represents a difference between column indexes of the first sample and the second sample and is a non-negative integer, or
wherein p=i−T and q=j+1, and T represents a difference between row indexes of the first sample and the second sample and is a non-negative integer.

9. The method of claim 8, wherein T is equal to 0, 1, or 2, or
wherein T is indicated in the bitstream.

10. The method of claim 7, wherein the first set of samples comprise a sample at (i+m)-th row and (j+n)-th column of the reconstructed latent representation, and each of m and n is an integer.

11. The method of claim 10, wherein −2<=m<=1 and −2<=n<=0, or
wherein T is equal to 1, and pairs of (m, n) have the following values: (1, −2), (0, −1), (0, −2), (−1, 0), (−1, −1), (−1, −2), (−2, 0), (−2, −1), and (−2, −2), or
wherein n is smaller than or equal to 0, or
wherein T is equal to 0, and pairs of (m, n) have the following values: (0, −1), (0, −2), (−1, 0), (−1, −1), (−1, −2), (−2, 0), (−2, −1), and (−2, −2), or
wherein T is equal to 0, and pairs of (m, n) have the following values: (−1, 2), (−1, 1), (−1, 0), (−1,−1), (−1, −2), (−2, 2), (−2, 1), (−2, 0), (−2,−1), (−2, −2), (−3, 2), (−3, 1), (−3, 0), (−3,−1), (−3, −2), and (−3, 2), or
wherein
$$\begin{matrix}m < 0 - T \times n and n <= 0 , or \\ m <= 0 and n < 0 - T \times m , or \\ m <= 0 and n <= 0 , or \\ - 3 <= m <= 0 and - 3 <= n <= 0 , or \\ - 3 <= m <= 2 and - 3 <= n <= 2 , or \\ - 1 <= m <= 0 and - 1 <= n <= 0 , or \\ m = - 1 and - 1 <= n <= 1.\end{matrix}$$

12. The method of claim 10, wherein an absolute value of m is smaller than or equal to M, an absolute value of n is smaller than or equal to N, and each of M and N is a non-negative integer.

13. The method of claim 12, wherein
M is equal to 2 and N is equal to 2, or
M is equal to 1 and N is equal to 1, or
M is equal to 3 and N is equal to 3.

14. The method of claim 1, wherein if a third sample of the first set of samples is unavailable, a value of the third sample is obtained by means of padding or sample replication, or
wherein samples of the reconstructed latent representation are processed row by row or column by column, or
wherein a shape of a processing kernel for processing the first sample is symmetric around a diagonal axis passing through the first sample, or
wherein the first set of samples are neighboring samples of the first sample.

15. The method of claim 14, wherein the value of the third sample is set to be one of: a fixed value, or a value of the nearest available sample of the third sample, or
wherein the value of the third sample is generated by a mirror padding or a circular padding;
wherein a transposing process is applied on the reconstructed latent representation before the processing;
wherein the first set of samples are determined based on a position of the first sample.

16. The method of claim 1, wherein information on at least one of the following is indicated in the bitstream: whether to process a plurality of samples of the reconstructed latent representation in parallel, or how to process the plurality of samples in parallel, or
wherein information on the first set of samples is indicated in the bitstream, or
wherein the reconstructed latent representation is partitioned into a plurality of regions, and the plurality of regions are processed independently, or
wherein the reconstructed latent representation is a quantized latent representation of the data, or
wherein the data comprise a picture of a video or an image.

17. The method of claim 1, wherein the conversion includes encoding the data into the bitstream, or
wherein the conversion includes decoding the data from the bitstream.

18. An apparatus for processing data comprising a processor and a non-transitory memory with instructions thereon, wherein the instructions upon execution by the processor, cause the processor to perform acts comprising:
processing, during a conversion between data and a bitstream of the data, a first set of samples of a reconstructed latent representation of the data and a second set of samples of the reconstructed latent representation by using a model, the first set of samples being associated with a first sample of the reconstructed latent representation and the second set of samples being associated with a second sample of the reconstructed latent representation; and
performing the conversion based on a result of the processing.

19. A non-transitory computer-readable storage medium storing instructions that cause a processor to perform acts comprising:
processing, during a conversion between data and a bitstream of the data, a first set of samples of a reconstructed latent representation of the data and a second set of samples of the reconstructed latent representation by using a model, the first set of samples being associated with a first sample of the reconstructed latent representation and the second set of samples being associated with a second sample of the reconstructed latent representation; and
performing the conversion based on a result of the processing.

20. A non-transitory computer-readable recording medium storing a bitstream of data which is generated by a method performed by a data processing apparatus, wherein the method comprises:
processing a first set of samples of a reconstructed latent representation of the data and a second set of samples of the reconstructed latent representation by using a model, the first set of samples being associated with a first sample of the reconstructed latent representation and the second set of samples being associated with a second sample of the reconstructed latent representation; and
generating the bitstream based on a result of the processing.
